(19) United States
(12) Patent Application Publication
(10) Pub. No.: US 2026/0169437 A1
(43) Pub. Date: Jun. 18, 2026

(54) TIMEPIECE COMPRISING A SHOCK-ABSORBING FASTENING DEVICE FOR A HOROLOGY MOVEMENT

(71) Applicant: The Swatch Group Research and Development Ltd, Marin (CH)

(72) Inventors: Joslain BOSSY, Yverdon-Ies Bains (CH); Simon GARCIN, Salavaux (CH); Yoann MOSTEIRO VAZQUEZ, Montmagny (CH)

(73) Assignee: The Swatch Group Research and Development Ltd, Marin (CH)

(21) Appl. No.: 19/375,680

(22) Filed: Oct. 31, 2025

(30) Foreign Application Priority Data
Dec. 17, 2024 (EP) 24220752.0

(51) Int. Cl. G04B 37/04

(52) U.S. Cl. CPC G04B 37/0427

(57) ABSTRACT

A timepiece (1) including a case (4) in which a horology movement (2) is turned. The movement (2) is held in the case (4) by a shock-absorbing fastening (10), the shock-absorbing fastening (10) including at least two blades (3), each blade (3) having two opposite ends (3c, 3d) attached, directly or indirectly, to the case (4) and to the horology movement (2) by fastening elements (7) engaging with first anchor points on the horology movement (2) and with second anchor points on the case (4). The first anchor points on the horology movement are inscribed on a first circle (C1) and the second anchor points are inscribed on a second circle (C2), the first circle (C1) and the second circle (C2) being concentric. The first anchor points (8a) and the second anchor points (8b) are not radially aligned.

### CROSS-REFERENCE TO RELATED APPLICATIONS

This application claims priority to European Patent Application No. 24220752.0 filed on December 17, 2024, the entire contents of which are incorporated herein by reference.

### TECHNICAL FIELD OF THE INVENTION

The present invention relates to a timepiece comprising a shock-absorbing fastening device for a horology movement, capable of reducing the impact of shocks on the horology movement.

### TECHNOLOGICAL BACKGROUND

Two or three casing clamps are generally used to assemble or fasten a horology movement inside a case, particularly inside a middle.

For example document CH 315649 describes a fastening device for fastening a horology movement in a case. The fastening device fastens the horology movement by means of several flexible casing clamps. These casing clamps have a support section connected to the horology movement and a fastening section inserted into a blank formed on the inner circumference of the middle.

In particular, this blank can be shaped such that the casing clamp can induce an adequate pre-tensioning force on the horology movement so as to clamp and hold the horology movement in position in the middle.

These fastening devices are rarely dimensioned to withstand the effects of shocks to the case. Such shocks can lead to loosening or even bending of the clamps on the middle, which amplifies the acceleration undergone by the horology movement and can cause damage to the horology movement.

To remedy this drawback of the clamps loosening following a shock, document CH 720282 proposes suspending a horology movement in a case using a support structure comprising a plurality of suspension triangles with ends attached to the plate on the horology movement and to the case. However, such a solution is hyperstatic in dynamic mode, which results in little damping effect on the horology movement and to an increase in stresses at the anchor points.

Consequently, there is a need to improve shock-absorbing fastening device with damping effect for horology movements.

### SUMMARY OF THE INVENTION

To this end, the invention provides a timepiece comprising a shock-absorbing fastening device for a horology movement, making it possible to remedy at least one of the aforementioned drawbacks.

The invention provides a flexible, shock-absorbing fastening solution for damping the stresses transmitted to the movement during a shock, while controlling and limiting the axial displacement of the horology movement in the case. Compared to the solutions in the prior art, the invention provides a solution that makes it possible to address the stresses associated with the maximum permissible axial displacement of a horology movement in a case, in order to avoid the amplification effects of accelerations on the horology movement.

In particular, the invention provides a timepiece comprising a shock-absorbing fastening device for a horology movement designed to hold said horology movement in a case of a timepiece while providing a damping effect so as to reduce the accelerations undergone by the horology movement in the event of a shock to the case or the glass.

Moreover, the invention comprises a timepiece comprising a shock-absorbing fastening device with improved reliability and robustness compared with solutions in the prior art, so as to ensure that it functions correctly in the event of repeated shocks.

To this end, the invention relates to a timepiece comprising a case housing a horology movement, said horology movement being held in said case by a shock-absorbing fastening device, the shock-absorbing fastening device comprising at least two blades, each blade having two opposite ends attached, directly or indirectly, to the case and to the horology movement by fastening elements engaging with first anchor points on the horology movement and with second anchor points on the case, characterised in that the first anchor points on the horology movement are inscribed on a first circle and in that the second anchor points are inscribed on a second circle, the first circle and the second circle being concentric, and in that the first anchor points and the second anchor points are radially offset relative to the centre of the circles C1 and C2, such that the first anchor points are not radially aligned with the second anchor points.

The shock-absorbing fastening device according to the invention makes it possible to connect the horology movement to the case while providing a damping effect so as to reduce or control the acceleration undergone by the horology movement during a shock.

Preferentially, the blades are arranged between the horology movement and the case to allow relative rotational displacement of the horology movement relative to the case around the axis of rotation running through the centre Z of the circles C1, C2, when the blades are elastically strained. The shock-absorbing fastening device according to the invention thus makes damping possible by combining an axial movement along the central axis running through the centre Z and a rotational movement around the central axis running through Z.

The horology movement is damped while ensuring the water resistance of the case, particularly at the winding stem. It may be necessary to provide a winding stem that can be disconnected to enable axial and rotational movement of the horology movement with no deterioration of the winding stem or of the water resistance of the case at the winding stem. Disconnection can take place at the connection between the horology movement and the winding stem or at the connection between the winding stem and the middle.

Preferentially, the winding stem has a predetermined flexibility that is sufficient to allow the horology movement to rotate in the event of a shock and/or to allow the horology movement to move axially in the event of a shock.

In addition to the characteristics mentioned in the previous paragraph, the timepiece according to the invention can have one or more complementary characteristics from among the following, taken individually or in any technically possible combination:

the at least two blades ensure damping of the horology movement by elastic strain of said at least two blades;

the at least two blades are arranged to allow relative displacement of the horology movement relative to the case in response to a shock, by elastic strain of said at least two blades causing the horology movement to rotate around an axis of rotation running through the centre of the first circle C1 and of the second circle C2;

at least two blades are arranged angularly equidistant from each other around the horology movement;

the at least two blades form a circular repeating pattern around the horology movement that is symmetrical relative to the axis of rotation running through the centre Z of the circles C1 and C2;

the at least two blades run in a tangential, or substantially tangential, direction relative to the first circle C1; a direction is considered to be tangential, or substantially tangential, when it forms, at any point on the circle C1, an angle of 90° +/- 5° with the radius of the circle C1;

the at least two blades have identical dimensions and/or mechanical properties;

the at least two blades have different dimensions and/or identical mechanical properties;

the at least two blades are made of a material chosen among: steel, resilient steel, superelastic shape memory alloy, amorphous metal, nickel-based superalloy, iron-nickel-based superalloy, cobalt-based superalloy, spring steel, composite materials, or a mixture or combination thereof;

the fastening elements comprise at least one screw;

the anchor points on the horology movement are arranged directly on a plate on the horology movement;

the horology movement comprises a casing support attached to a plate on the horology movement, the anchor points on the horology movement being arranged on the casing support;

each blade is formed by a stack of several superimposed blades

### BRIEF DESCRIPTION OF THE FIGURES

Other features and advantages of the invention will be apparent from the following detailed description of the invention, with reference to the attached figures, in which:

FIG. 1 is an exploded perspective view of a horology movement and of a shock-absorbing fastening device according to a first embodiment of the invention; in this embodiment, the shock-absorbing fastening device comprises four stacks and a casing support to which the horology movement is clamped;

FIG. 2 is a perspective view as shown in FIG. 1 in an assembled configuration of the horology movement and of the shock-absorbing fastening device;

FIG. 3 is a perspective view of the assembly illustrated in FIG. 2, shown on top of a housing in a case of a timepiece;

FIG. 4 is a top view of a timepiece comprising the horology movement fitted in the case using the shock-absorbing fastening device according to the invention.

For greater clarity, identical or similar elements in the different embodiments are labelled with identical reference numbers in all figures.

### DETAILED DESCRIPTION OF THE INVENTION

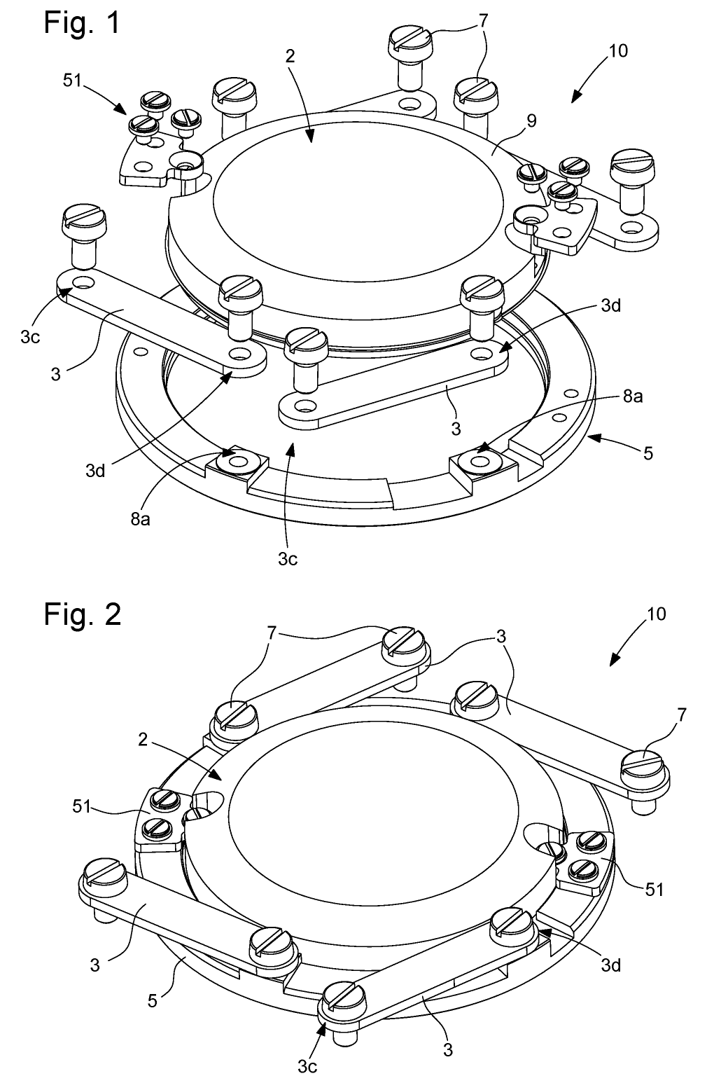

FIGS. 1, 2, 3 and 4 describe a shock-absorbing fastening device 10 for a horology movement 2 designed to hold said horology movement 2 in a case 4 of a timepiece 1.

The shock-absorbing fastening device 10 according to the invention enables the horology movement 2 to be connected to the case 4 while damping the horology movement 2 in the event of a shock. The shock-absorbing fastening device 10 according to the invention makes it possible in particular to reduce or control the acceleration undergone by the horology movement 2 during a shock.

According to the embodiment shown, the shock-absorbing fastening device 10 comprises a casing support 5 to which the horology movement 2 is attached, for example by retainer clamps 51. The casing support 5 is, for example, a casing circle. The casing support 5 is an optional element that facilitates the casing of the horology movement 2. However, according to the invention, the horology movement 2 can also be directly cased in the case 4 without the use of an intermediate casing support 5 such as the one shown.

The shock-absorbing fastening device 10 according to the invention comprises at least two blades 3 acting as a casing clamp for the horology movement and as a damper for the horology movement in the event of shocks.

In the example shown, the shock-absorbing fastening device 0 comprises four blades 3. However, the shock-absorbing fastening device 10 can comprise at least two blades 3, and for example up to six blades 3.

The various blades 3 in the shock-absorbing fastening device 10 can have different dimensions and/or mechanical properties, for example in terms of width and/or thickness and/or of Young's modulus.

The various blades 3 in the shock-absorbing fastening device 10 can have identical dimensions and/or identical mechanical properties.

In the example shown in FIGS. 1 to 4, the blades 3 have identical dimensions.

The number of blades 3 will be chosen according to the desired damping and displacement of the horology movement relative to the case 4 for a given shock.

Preferably, the material of the blades 3 is chosen from the following list: steel, resilient steel, superelastic shape memory alloy, amorphous metal, nickel-based superalloy, iron-nickel-based superalloy, cobalt-based superalloy, spring steel, composite materials, or a mixture or combination thereof.

Preferentially, the blades 3 are made of a super-elastic shape memory material, for example a nickel-titanium alloy such as Nitinol.

Nitinol is a superelastic shape memory alloy. The composition (meaning the percentage of nickel and of titanium) of the Nitinol is chosen so that, in the temperature range in which the timepieces are used (for example, from -10°C to 50°C), the Nitinol is in the austenitic phase, and is therefore superelastic.

In this document, “superelastic alloy” refers to an alloy with a yield point distortion of more than 2%, or even more than 5%, or even more than 8%.

For example, the blades 3 can have one or more of the following characteristics: thickness comprised between 0.2 and 2 mm, width comprised between 2 and 6 mm, and length comprised between 8 and 25 mm.

Each blade 3 has two opposite ends, a first case end 3c and a second movement end 3d. Each end 3c, 3d has an axial or cylindrical hole suitable for the passage of fastening elements 7 for attaching the blade 3 respectively to the case 4 and to the horology movement 2, via the casing support 5 if there is a casing support, so as to case the horology movement 2 in the case 4.

The fastening elements 7 are configured to go through the holes in the ends 3c, 3d of the blades 3 and to engage with first anchor points 8a arranged on the casing support 5 (or directly on the plate 9 of the horology movement 2 when there is no casing support 5) and with second anchor points 8b arranged on the case 4.

For example, the fastening elements 7 are screws with threaded bodies designed to go through the holes in the ends of the blades 3, and the anchor points 8a, 8b are tappings designed to hold the threaded bodies of the screws.

The ends 3c, 3d of the blades 3 are thus rigidly and reversibly screwed to the casing support 5 (or to the plate 9 of the horology movement 2) and to the case 4. The blades 3 can also be attached by other equivalent means known to the person skilled in the art.

According to the invention, the first anchor points 8a on the horology movement are inscribed on a first circle C1 and the second anchor points 8b are inscribed on a second circle C2, the first circle C1 and the second circle C2 being concentric, with centre Z.

Preferentially, the anchor points 8a, 8b are arranged between the horology movement 2 and the case 4 so that the blades 3 can generate a relative rotational displacement of the horology movement 2 relative to the case 4 around the axis of rotation running through the centre Z when the blades 3 are elastically strained. The shock-absorbing fastening 10 according to the invention thus combines an axial movement along the axis running through the centre Z with a rotational movement when the blades 3 are elastically deformed.

The first anchor points 8a and the second anchor points 8b are radially offset relative to the centre of the circles C1 and C2, such that the first anchor points are not radially aligned with the second anchor points.

Preferentially, the blades 3 are arranged angularly equidistant from each other around the horology movement 2.

Preferably, the various blades 3 form a circular repeating pattern around the horology movement 2 that is preferentially symmetrical relative to the axis of rotation running through the centre Z of the circles C1 and C2.

Preferentially, the blades 3 are arranged so as to run in a direction tangential to the first circle C1.

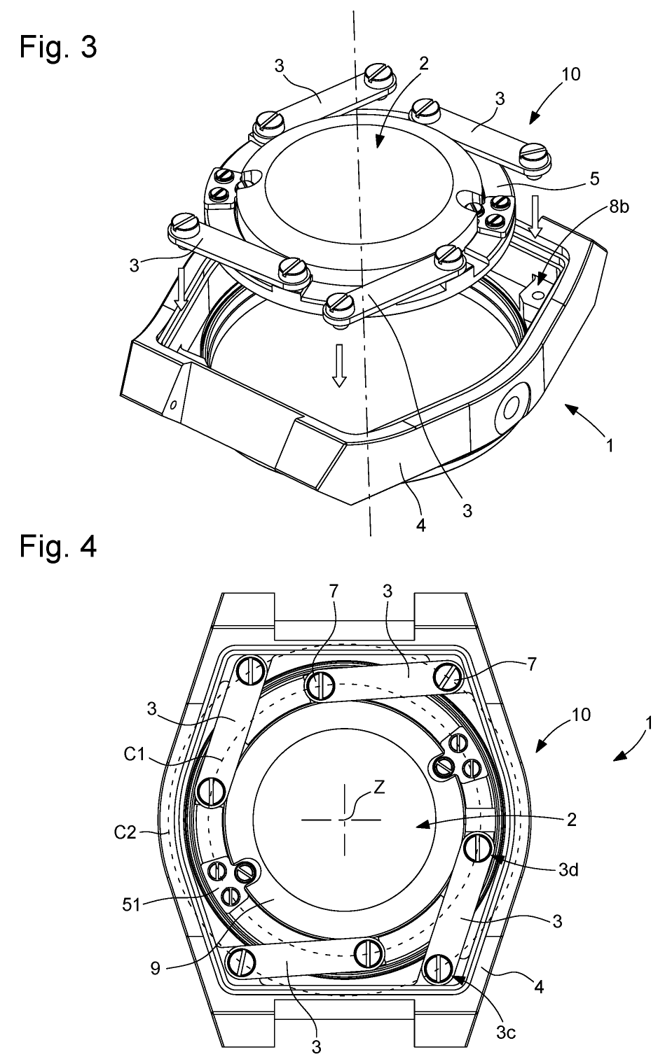

Referring now to FIGS. 3 and 4, once the blades 3 have been fastened to the horology movement 2, either directly to the plate 9 or via the casing support 5, the assembly formed by the horology movement 2 and the blades 3 is fitted into a bed in the case middle 4.

According to the example shown, the case 4 has surfaces for holding and supporting the case ends 3c of the blades 3. Preferably, the anchor points 8b for the case 4 are provided on these holding surfaces. Of course, the case 4 comprises at least as many holding surfaces as there are blades 3 for fastening the horology movement 2.

The proposed arrangement is compact and reliable, minimising displacement while damping the horology movement in the event of shocks in order to protect the horology movement.

Moreover, the shock-absorbing fastening according to the invention keeps the horology movement from becoming detached from the case in the event of a shock.

According to a variant embodiment, each blade 3 on the shock-absorbing fastening 10 is formed by a stack of several superimposed blades.

Preferably, the shock-absorbing fastening can comprise one or more of the following manufacturing steps: water jet cutting, three-axis machining, machining, turning, laser cutting, stamping.

The above description of the invention is provided by way of example. It is understood that the person skilled in the art is capable of arriving at different variants of the invention without departing from the scope of the invention.

1. A timepiece comprising a case housing a horology movement, said horology movement being held in said case by a shock-absorbing fastening, the shock-absorbing fastening comprising at least two blades, each blade having two opposite ends attached, directly or indirectly, to the case and to the horology movement by fastening elements engaging with first anchor points on the horology movement and with second anchor points on the case, wherein the first anchor points on the horology movement are inscribed on a first circle and in that the second anchor points are inscribed on a second circle, the first circle and the second circle being concentric, and in that the first anchor points and the second anchor points are not radially aligned.

2. The timepiece according to claim 1, wherein said at least two blades ensure damping of the horology movement by elastic strain of said at least two blades.

3. The timepiece according to claim 1, wherein said at least two blades are arranged to allow relative displacement of the horology movement relative to the case in response to a shock, by elastic strain of said at least two blades causing the horology movement to rotate around an axis of rotation running through the centre of the first circle and of the second circle.

4. The timepiece according to claim 1, wherein said at least two blades are arranged angularly equidistant from each other around the horology movement.

5. The timepiece according to claim 3, wherein said at least two blades form a circular repeating pattern around the horology movement that is symmetrical relative to the axis of rotation running through the centre of the first and second circles.

6. The timepiece according to claim 1, wherein said at least two blades run in a tangential direction relative to the first circle.

7. The timepiece according to claim 1, wherein said at least two blades have identical dimensions and/or identical mechanical properties.

8. The timepiece according to claim 1, wherein said at least two blades have different dimensions and/or mechanical properties.

9. The timepiece according to claim 1, wherein said at least two blades are made of a material chosen among: steel, resilient steel, superelastic shape memory alloy, amorphous metal, nickel-based superalloy, iron-nickel-based superalloy, cobalt-based superalloy, spring steel, composite materials, or a mixture or combination thereof.

10. The timepiece according to claim 1, wherein the fastening elements comprise at least one screw.

11. The timepiece according to claim 1, wherein the anchor points on the horology movement are arranged directly on a plate on the horology movement.

12. The timepiece according to claim 1, wherein the horology movement comprises a casing support attached to a plate (on the horology movement, the anchor points on the horology movement being arranged on the casing support.

13. The timepiece according to claim 1, wherein each blade is formed by a stack of several superimposed blades.
